(19) United States
(12) Patent Application Publication
(10) Pub. No.: US 2025/0056189 A1
(43) Pub. Date: Feb. 13, 2025

(54) METHOD AND SYSTEM FOR PRESSURE-BASED MOTION TRACKING

(71) Applicant: ColdChase Inc., Edmonton (CA)

(72) Inventors: Viet HOANG, Edmonton (CA); Kenneth Brizel, Edmonton (CA)

(21) Appl. No.: 18/798,463

(22) Filed: Aug. 8, 2024

Related U.S. Application Data
(60) Provisional application No. 63/519,161, filed on Aug. 11, 2023.

(51) Int. Cl. H04W 4/029; G01L 13/06; G01S 19/42; H04W 4/02

(52) U.S. Cl. CPC H04W 4/029; G01L 13/06; G01S 19/42; H04W 4/027

(57) ABSTRACT

Embodiments herein generally relate to a method and system for pressure-based motion tracking. In at least one example, the method includes monitoring pressure data generated by at least one pressure sensor of a motion tracking system; determining differential pressure (DP) values from the pressure data; determining if the DP values exceed a predetermined threshold; and if the DP values exceed the threshold, activating a location sensing unit, of the motion tracking system, to output location data.

### CROSS-REFERENCE TO RELATED APPLICATION

The present application claims priority to, and the benefit of, U.S. Provisional Patent Application No. 63/519,161 titled “METHOD AND SYSTEM FOR PRESSURE-BASED MOTION TRACKING”, filed on Aug. 11, 2023, the entire contents of which are incorporated herein by reference.

### FIELD

The present invention generally relates to motion tracking, including motion tracking for low power applications, and more particularly, to a method and system for pressure-based motion tracking.

### BACKGROUND

Hardware and other equipment (collectively referred to herein as “assets”) can be deployed in stationary locations for extended periods. For example, an asset can be deposited in storage for extended periods, or otherwise deployed in fixed installations. In these cases, it is desirable to remotely monitor and track the location and displacement of the asset. For example, in the event that a stored asset is stolen, the asset is tracked and recovered through remote monitoring.

To that end, motion tracking of assets is often effected through a location sensing unit, mounted to the asset. The sensing unit can be a global navigation satellite system (GNSS), such as a global positioning system (GPS). The sensing unit can transmit the asset's location to a remote computing terminal. An on-board and low power battery system typically powers the sensing unit.

Location sensing units (e.g., GNSS units) are, however, power intensive. Accordingly, maintaining the sensing unit “on” for extended periods, i.e., to enable continuous tracking, can quickly deplete the on-board power source. Continuous motion tracking is therefore a challenge for low power applications.

### SUMMARY OF VARIOUS EMBODIMENTS

In accordance with a broad aspect, there is provided a method for pressure-based motion tracking, comprising: monitoring pressure data generated by at least one pressure sensor of a pressure-based motion tracking system; determining differential pressure (DP) values from the pressure data, wherein the DP values correspond to a difference in the pressure data between at least two sampling instances; determining if the DP values exceed a predetermined threshold; and if the DP values exceed the predetermined threshold, generating an output indicating that an asset, associated with the motion tracking system, has moved.

In some examples, if the DP values exceed the predetermined threshold, the method further comprises activating a location sensing unit, of the motion tracking system, to output location data.

In some examples, the predetermined threshold is 0.2 millibars.

In some examples, the location sensing unit comprises a global navigation satellite system (GNSS).

In some examples, the predetermined threshold is a first predetermined threshold, and wherein after activating the location sensing unit: continuing monitoring the pressure data generated by the at least one pressure sensor, wherein the pressure data is generated at sampling instances; determining the DP values from the pressure data; determining if the DP values fall below a second predetermined threshold; and if the DP values fall below the second predetermined threshold, deactivating the location sensing unit.

In some examples, the method further comprises determining if the DP values fall below the second predetermined threshold for a period of time.

In some examples, the first predetermined threshold is the same or different from the second predetermined threshold.

In some examples, the method further comprises monitoring acceleration data generated by at least one accelerometer of the motion tracking system; determining differential acceleration (DA) values from the acceleration data; and activating the location sensing unit if one or more of the DP and DA values exceed a respective predetermined threshold.

In some examples, the method further comprises identifying one or more of (i) motion properties of the asset, and (ii) target movement conditions; based on the identifying, determining to monitor accelerometer data, in addition to the pressure data; monitoring acceleration data generated by at least one accelerometer of the motion tracking system; determining differential acceleration (DA) values from the acceleration data; and activating the location sensing unit if one or more of the DP and DA values exceed a respective predetermined threshold.

In some examples, the method further comprises monitoring one or more threshold adjusting conditions, and adjusting the predetermined threshold if a threshold adjusting condition is detected.

In another broad aspect, there is provided a pressure-based motion tracking system, comprising: at least one pressure sensor; a location sensing unit; and at least one processor coupled to the at least one pressure sensor and the location sensing unit, and configured for: monitoring pressure data generated by the at least one pressure sensor, wherein the pressure data is generated at sampling instances; determining differential pressure (DP) values from the pressure data, wherein the DP values correspond to a difference in the pressure data between at least two sampling instances; determining if the DP values exceed a predetermined threshold; and if the DP values exceed the predetermined threshold, generating an output indicating that an asset, associated with the motion tracking system, has moved.

In some examples, system further comprises a location sensing unit coupled to the at least one processor, and if the DP values exceed the predetermined threshold, the at least one processor is further configured for activating the location sensing unit, of the motion tracking system, to output location data.

In some examples, the predetermined threshold is 0.2 millibars.

In some examples, the location sensing unit comprises a global navigation satellite system (GNSS).

In some examples, the predetermined threshold is a first predetermined threshold, and after activating the location sensing unit, the at least one processor is further configured for: continuing monitoring the pressure data generated by the at least one pressure sensor; determining the DP values from the pressure data; determining if the DP values fall below a second predetermined threshold; and if the DP values fall below the second predetermined threshold, deactivating the location sensing unit.

In some examples, the method further comprises determining if the DP values fall below the second predetermined threshold for a period of time.

In some examples, the first predetermined threshold is the same or different from the second predetermined threshold.

In some examples, the system further comprises at least one accelerometer coupled to the at least one processor, and the at least one processor is further configured for: monitoring acceleration data generated by the at least one accelerometer; determining differential acceleration (DA) values from the acceleration data; and activating the location sensing unit if one or more of the DP and DA values exceed a respective predetermined threshold.

In some examples, the system further comprises at least one accelerometer coupled to the at least one processor, wherein the at least one processor is further configured for: identifying one or more of (i) motion properties of the asset, and (ii) target movement conditions; based on the identifying, determining to monitor accelerometer data, in addition to the pressure data; monitoring acceleration data generated by the at least one accelerometer; determining differential acceleration (DA) values from the acceleration data; and activating the location sensing unit if one or more of the DP and DA values exceed a respective predetermined threshold.

In some examples, the at least one processor is further configured to monitor one or more threshold adjusting conditions, and adjusting the predetermined threshold if a threshold adjusting condition is detected.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is an example system for pressure-based motion tracking.

FIG. 2 is a comparative illustration showing optimal use cases for acceleration-based versus pressure-based motion tracking.

FIG. 3A is a process flow for an example method for pressure-based motion tracking.

FIG. 3B is another process flow for an example method for pressure-based motion tracking.

FIG. 4A is a process flow for an example method for combined pressure-based and acceleration-based motion tracking.

FIG. 4B is another process flow for an example method for combined pressure-based and acceleration-based motion tracking.

FIG. 5A is a process flow for an example method for motion tracking using one or more sensor types.

FIG. 5B is another process flow for an example method for motion tracking using one or more sensor types.

FIG. 6 is a process flow for dynamically adjusting pre-defined thresholds.

FIG. 7 shows plots of measured pressure data in an example trial run, and corresponding calculated differential pressure (DP) values.

FIG. 8 shows further plots of measured pressure data in an example trial run, and corresponding calculated differential pressure (DP) values.

FIG. 9 is a simplified hardware block diagram for an example motion tracking system.

### DETAILED DESCRIPTION OF THE EMBODIMENTS

Embodiments herein generally relate to a method and system for pressure-based motion tracking, and with particular use for low power applications.

### I. General Overview

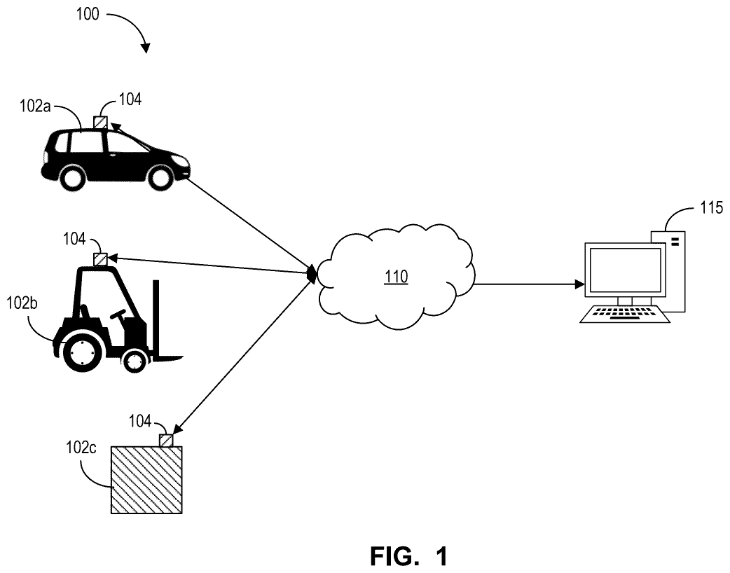

FIG. 1 shows an example system (100) for pressure-based motion tracking, in accordance with disclosed embodiments.

As shown, system (100) includes various assets (102). As used herein, an “asset” broadly refers to any object which requires motion tracking. By way of non-limiting examples, this includes any mobile or non-mobile equipment, hardware, vehicles, objects or otherwise. For instance, assets (102) can include a vehicle (102a), forklift (102b), or any other object (102c).

Assets (102) can be located in stationary positions for extended periods. For example, this includes where an asset is located in storage, or otherwise deployed in fixed installations. In these cases, remote monitoring and tracking is desirable to ensure that the asset is not moved or dislocated from its fixed position. In other cases, it is expected that the asset will eventually move, in which case, it is desirable to track if, when and where the asset moves.

To assist in motion tracking, a motion tracking system (104) is typically mounted to each asset (102). The motion tracking system (104) monitors motion of the asset (102) to detect movement. It can also track location of the asset (102), as it is being moved.

As shown, the tracking system (104) is connected, via a network (110), to a remote computing terminal (115). Network (110) can be a wired or wireless network, as the case may be.

Computing terminal (115) includes any type of computer, including a desktop terminal, as well various types of user devices (e.g., smartphones). When asset motion is detected, the tracking system (104) generates and transmits a notification (or other update) to the computing terminal (115). Tracking system (104) can also transmit position coordinates, as the asset is being moved. Accordingly, a remote operator can monitor the asset, e.g., in the case of theft.

As noted in the background, existing motion tracking techniques rely on a global navigation satellite systems (GNSS) (e.g., GPS) installed within the tracking system (104). The GNSS enables motion detection and location tracking. The tracking system (104) also includes a small on-board battery, to power the GNSS.

GNSS's (and other similar systems) are, however, power intensive. Accordingly, if the GNSS is continuously turned “on”, e.g., for continuous motion tracking-the on-board battery source is likely to quickly deplete. GNSS tracking is therefore impractical for low power applications, especially where an asset (102) is fixed in the same location for extended periods.

To mitigate this challenge, it is possible to couple the GNSS to an accelerometer. The accelerometer is always “on” to detect motion, while the GNSS is turned “off” to conserve battery. If the accelerometer detects motion, only then is the GNSS activated to enable location tracking. Battery power is conserved over the long run because using the accelerometer continuously is less power intensive than activating the GNSS continuously.

Still, accelerometer-based tracking suffers from accuracy problems. An accelerometer can generate both false positives, and false negatives.

False positives occur, for example, when an asset vibrates in its stationary location. The accelerometer detects the vibration, and continuously triggers the GNSS to activate despite the asset (102) not having moved. This depletes the on-board battery source.

In contrast, a false negative can occur if the asset (102) moves, but at a very steady, constant speed over a smooth surface (e.g., a well-paved road). The accelerative forces are not sufficient to trigger a detected motion. In turn, the accelerometer does not trigger the GNSS to activate for location tracking.

Use of accelerometers is also not power efficient. This is because, to capture instantaneous acceleration, the accelerometer is operated continuously at a very high sampling rate. Additionally, accelerometers generate data that demands significant on-board processing to resolve motion parameters. High sampling rate coupled with high computational requirements deplete the on-board power source over the long term.

In view of the foregoing, it has been appreciated that pressure-based motion tracking can provide a convenient solution for motion tracking in low power applications. In particular, it has been appreciated that motion can be detected by monitoring surrounding changes in pressure-e.g., surrounding the asset-over time. For instance, when an asset begins moving, it may induce a sudden pressure change from the air moving around the asset in motion. Pressure changes can also result from changes in elevation if the asset's movement has a vertical component. Accordingly, in disclosed examples, a pressure sensor is used to detect motion, thereby activating a location sensing unit (e.g., a GNSS) as necessary. Pressure sensors can be used in addition to, or in the alternative of, accelerometers.

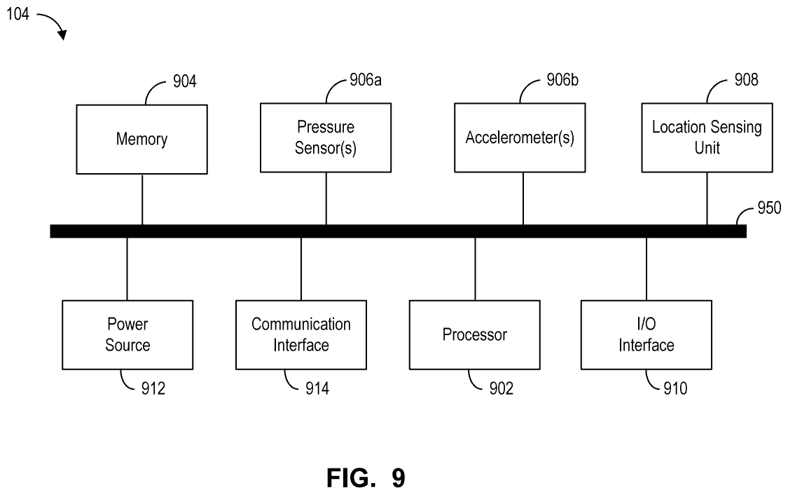

In accordance with this, disclosed embodiments use motion tracking systems (104) that include one or more pressure sensors (906a) in conjunction with a location sensing unit (908) (e.g., a GNSS) (FIG. 9). In some examples, the system (104) also includes accelerometers (906b). The sensors in the motion tracking system (104) may be collectively referred to as the “sensor subsystem”.

As shown in FIG. 9, system (104) can also include a processor (902) coupled to the sensors (906), as well as to a memory (904), input/output (I/O) interface (910), an on-board power source (912) and a communication interface (914). In other cases, the power source (912) is externally located, e.g., including via a renewable energy source (e.g., solar panels) mounted to the asset, a cigarette lighter adapter inside the asset (e.g., a vehicle), or a wall outlet.

In contrast to using accelerometers, it is believed that using pressure sensor(s) minimizes the incidences of false positives and/or false negatives. This ensures that the location sensing unit (908) is turned on only when required, thereby preserving the on-board battery (912).

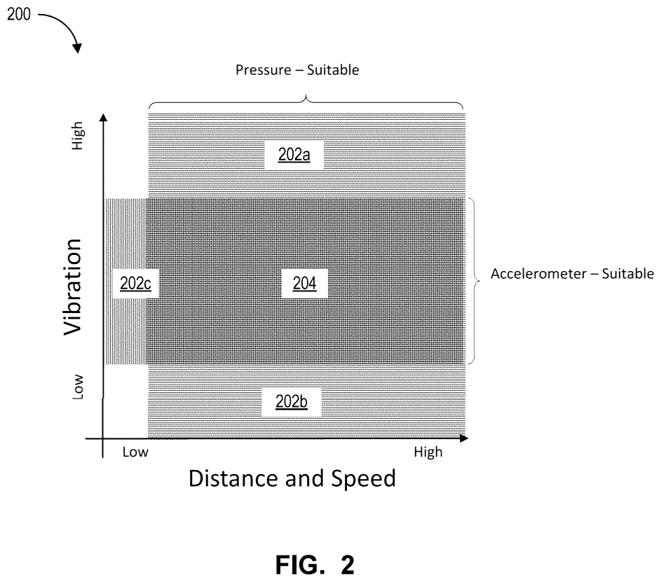

FIG. 2 is a comparative plot (200), and shows applications where pressure sensors may minimize incidences of false positives and false negatives.

As shown, pressure sensors minimize false positive when tracking assets that typically vibrate in-place (202a). Despite the asset vibrating, the measured pressure is constant because the asset has not moved. Therefore, while high vibrations would ordinarily trigger the accelerometer, they would not trigger the pressure sensor. In this case, the location sensing unit (908) would not be activated, thereby conserving battery power.

A pressure sensor also minimizes false negatives. For example, where an asset is moving with very low vibrations (202b) (e.g., along a paved road), the motion is still detectable through a gradual change in monitored pressure. Therefore, while such movement is not sensed by an accelerometer, it is still sensed by the pressure sensor. In this case, the location sensing unit (908) would be activated, to ensure location tracking of the asset.

Pressure sensors also provide a more power efficient alternative to accelerometers. For instance, unlike accelerometers, pressure sensors do not operate on the principle of detecting instantaneous changes in pressure. Rather, a pressure sensor detects motion by monitoring absolute pressure over time, and is used to observe pressure changes in the order of minutes. Accordingly, unlike accelerometer, pressure sensors do not require operation at high sampling rates in order to detect instantaneous pressure changes. Additionally, unlike accelerometers, processing pressure data requires low processing and computational requirements. Accordingly, the use of pressure sensors is likely to be more power efficient over the long term.

In some examples, the disclosed embodiments provide and enable motion tracking using an average current draw, from the power source (912), at 100 μA or lower.

### II. Example Methods

The following is a description various example methods using pressure-based motion tracking.

### (i.) Pressure-Based Motion Tracking.

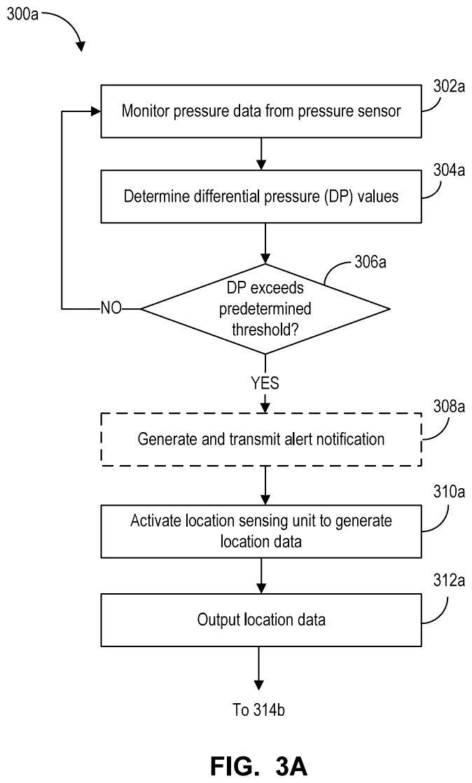

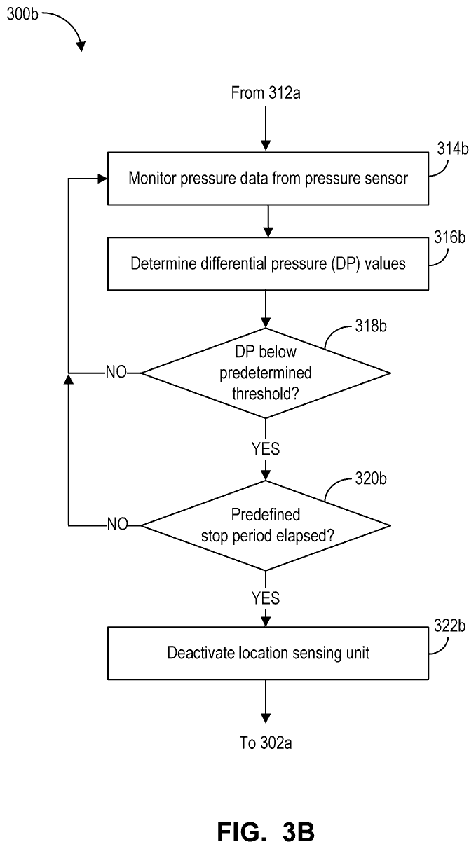

FIG. 3A shows a process flow for an example method (300a) for pressure-based motion tracking. Method (300a) provides an example of motion-tracking using only monitored pressure data. In at least one example, method (300a) is executed by the processor (902), of the motion tracking system (104).

As shown, at (302a), the tracking system (104) monitors pressure data generated by the pressure sensor (906a). The pressure data can be monitored in real time, or near real time. The pressure sensor (906a) can operate at any desired sampling rate. In some examples, a low sampling rate is selected to conserve on-board power usage.

During (302a), the location sensing unit (908) may be in an inactive or “off” state, so as to minimize power consumption, e.g., from power source (912).

At (304a), the tracking unit (104) analyzes and/or processes the monitored pressure data to determine differential pressure (DP) values. As used herein, a “differential pressure (DP)” value corresponds to the differences between pressure readings or measurements in at least two sampling instances, e.g., such as in a current time sampling instance and a previous time sampling instance (e.g., a previous iteration of method (300a)). The previous sampling instance may be the immediately previous sampling instance, or any other prior sampling instance.

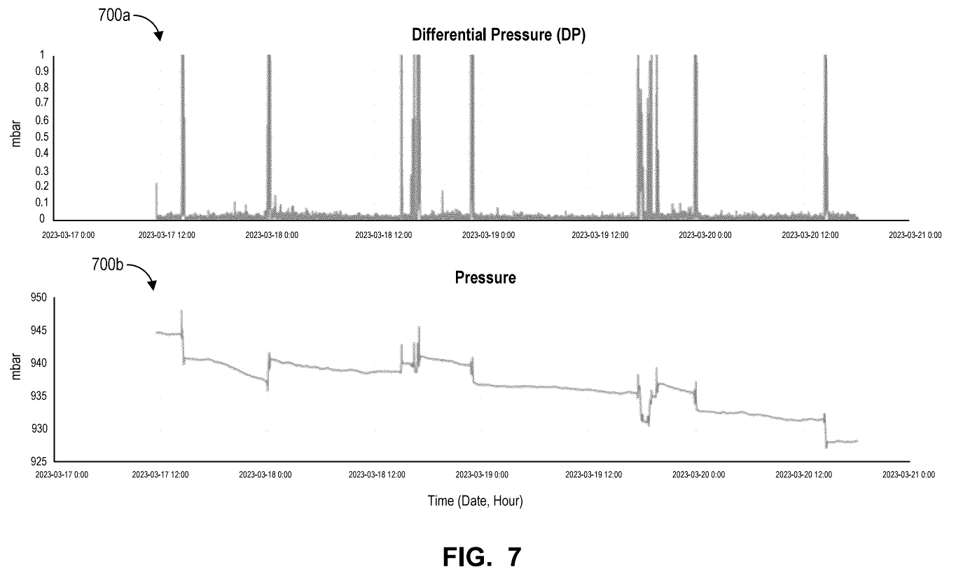

By way of example, FIG. 7 shows example plots of: (i) absolute values of monitored pressure data (700b) monitored over time (i.e., several days), at act (302a), for a moving asset, and corresponding (ii) differential pressure (DP) values (700a) calculated at act (304a) between sampling instances.

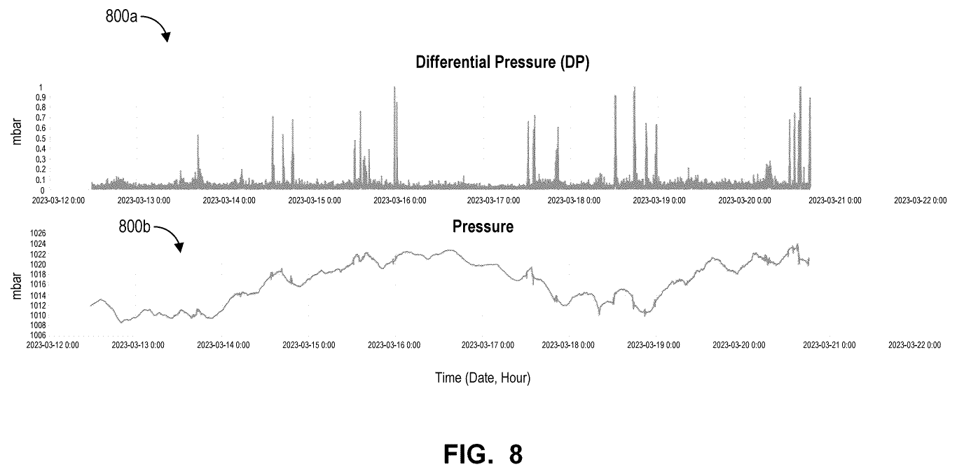

FIG. 8 also shows further example plots of: (i) absolute values of monitored pressure data (800b) at different sampling instances, and corresponding (ii) DP values (800a) calculated based on the monitored pressure data.

The units of the pressure data, in plots (700b) and (800b), may be expressed in millibars (mbar).

In each of FIGS. 7 and 8, the peaks in the DP data (700a), (800a) provides a fair indicator of whether or not an asset is moving. The large peaks in the DP (e.g., corresponding to changes greater than 0.2 mbar over a timespan of a minute) indicate when the asset is moving, while the asset (102) is stationary in between the larger peaks. In FIG. 7, it is also observed that the asset (102) is moved over a significant difference in elevation, which appears in the absolute pressure plot (700b) as a distinct step in the pressure.

Continuing with reference to FIG. 3A, at (306a), it is determined whether the DP resolved at (304a), exceeds a predetermined threshold. If the DP does not exceed the threshold, then the asset (102) is determined to be still stationary, and no movement has occurred. In this case, method (300a) returns to act (302a) to continue monitoring pressure data generated by the pressure sensor (906a) such that it can obtain the next sampling instance of pressure reading at (302a). In the next iteration, at (304a), the subsequent pressure reading can be compared to the pressure reading from the previous iteration (or any other iteration). In this manner, acts (302a)-(306a) can iterate for each new pressure reading received, or any multiple thereof.

Otherwise, if the DP exceeds the predetermined threshold, then the tracking system (104) determines that the asset (102) has been displaced from its previous location. Accordingly, at (308a), in at least some examples, the tracking system (104) generates and transmits an alert notification, signaling the displacement of the asset (102). This notification can be transmitted, for example, to the computing device (115), via the network (110) (FIG. 1). The notification (e.g., visual, auditory, etc.) can be displayed on a display interface or audio interface of computing device (115).

In at least one example, the predetermined threshold, used at act (306a), is approximately a DP of 0.2 mbar over the time span of one minute. It has been observed through trials that if a lower threshold than 0.2 mbar is used, then weather changes (e.g. wind gusts) can occasionally trigger the pressure sensor, and thereby generate false positives.

At (310a), responsive to a positive determination at (306a), the tracking system (104) can activate the location sensing unit (908). For instance, this can involve routing power from the power source (912) to the location sensing unit (908), or otherwise “waking up” the location sensing unit (908).

At (312a), the activated location sensing unit (908) can start monitoring location data (e.g., GPS coordinates) of the asset (102). Sensing unit (908) may then output the location data. The output can be in any suitable form. For example, the location data can be stored locally on memory (904) (FIG. 9), displayed on a display interface of the tracking system (104) and/or transmitted to any other external computing device or memory. In some examples, the sensing unit (908) transmits monitored location data to the computing device (115), for motion tracking. The location data can be transmitted in real time or near real time, to the computing device (115) or any other external computing device.

In some examples, in order to further reduce power consumption, at (310a), the location sensing unit (908) is periodically activated while motion is detected, rather than being activated continuously. The activation period can be adjustable (e.g. in a range of every 1 minute, to every 15 minutes, as necessary). In these examples, the location sensing unit (908) can be temporarily deactivated as soon as it generates a valid location fix at (312a) (or times out), and is then activated again at the next period if motion is still detected.

In some examples, if the DP exceeds the predetermined threshold, the system may simply generate an output indicating that the asset has moved.

FIG. 3B shows another process flow for an example method (300b) for pressure-based motion tracking. In at least one example, method (300b) is executed by the processor (902), of the motion tracking system (104).

More generally, while method (300a) is used to activate the location sensing unit (908), method (300b) is used to deactivate the sensing unit (908). For example, if the tracking system (104) determines that the asset (102) is no longer moving, it may deactivate the sensing unit (908) to continue conserving on-board power.

In some examples, method (300b) is an extension to method (300a), and follows after act (312a) (FIG. 3A) (as shown). In other examples, method (300b) may be a stand-alone method, that occurs independently and/or separately from method (300a).

As shown, at (314b), the tracking system (104) can continue to monitor pressure data generated by the pressure sensor (906a). At (316b), the DP values can continue to be determined, based on the monitored pressure data received at new time sampling instances. In some examples, it is assumed that the location sensing unit (908) is activated (or intermittently activated) during acts (314b) and (316b), and continues to monitor and output location data (e.g., acts (310a) and (312a) in FIG. 3A).

At (318b), it is determined whether the current DP is below a predetermined threshold. The threshold can be the same or different, than the threshold in act (306a) (e.g., 0.2 mbar). If not, then the method returns to act (314b) to continue monitoring. Otherwise, an initial determination is made that the asset (102) is no longer moving, thereby resulting in little change to the DP values between sampling instances.

In some examples, at (320b), it is determined whether the DP has fallen below the threshold for at least a predefined stop period (e.g., five minutes). This is to ensure that the asset (102) has indeed stopped movement. If not, the method returns to act (314b) and continues to iterate until the stop period has elapsed. In some examples, any other metric is used at (320b), such as ensuring the DP is below the threshold for a predetermined number of iterations of method (300b), sampling instances, etc.

At (322b), if the stop period has elapsed, the tracking system (104) can deactivate the location sensing unit (908) to conserve battery. For example, the tracking system (104) can cut-off power to the sensing unit (908), or otherwise transmit a deactivation signal to the sensing unit (908).

In some cases, act (320b) is not necessary, and the method may directly proceed from act (318b) to act (322b).

Once act (322b) is completed, the method may return to re-iterating method (300a) (e.g., starting from act (302a)) to monitor if the asset (102) begins moving again. In this manner, the tracking system (104) can continuously cycle between methods (300a) and (300b) in order to activate and/or deactivate the location sensing unit (908), as needed. In other examples, if method (300b) is a stand-alone method, then the method simply terminates at act (322b).

### (ii.) Pressure and Acceleration Based Motion Tracking.

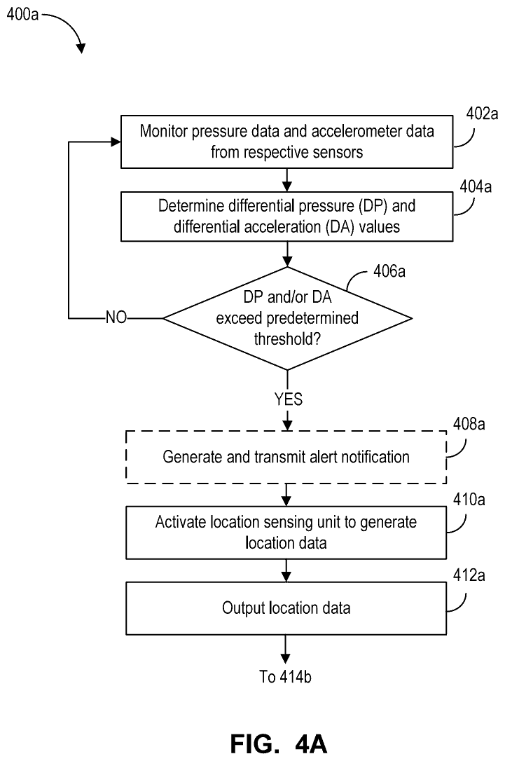

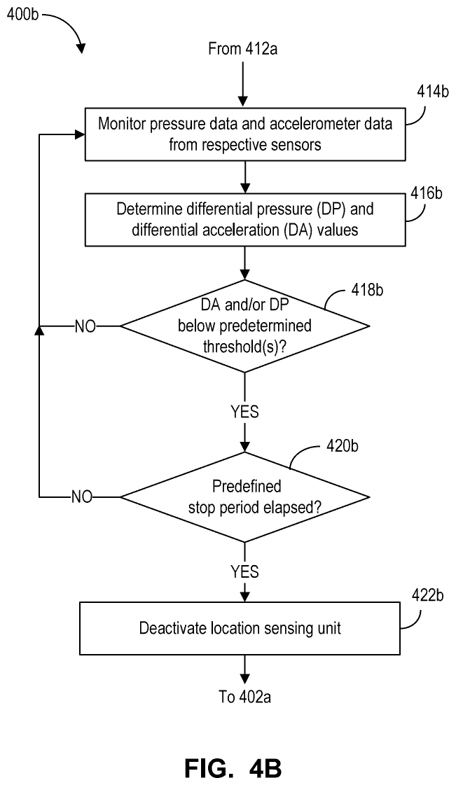

FIG. 4A shows a process flow for an example method (400a) for pressure-based and acceleration-based motion tracking.

Method (400a) provides an example of motion-tracking using a combination of the pressure sensor (906a) and the accelerometer (906b). Method (400a) may also be executed by the processor (902) of the motion tracking system (104).

More generally, method (400a) can provide for enhanced accuracy by combining the advantages of using both pressure and acceleration data. For instance, as best shown in FIG. 2, the accelerometer data may provide enhanced motion detection for small distance displacement of an asset (102) (e.g., region (202c)). Pressure changes over small displacement distances may not be detectable by a pressure sensor (906a). There are also cases where the accelerometer and pressure sensor may provide comparable advantages (e.g., region (204)), and therefore can act as a back-up to one another.

As shown, at (402a), both pressure data and accelerometer data are monitored, from respective pressure sensors and accelerometers (906a), (906b). In some examples, the location sensing unit (908) is deactivated, during the monitoring, to conserve battery power.

At (404a), the tracking system (104) can determine the differential pressure (DP) values, and differential acceleration (DA) values, from the respective sensor data. The values can be determined as between a current sampling instance, and a previous sampling instance.

As used herein, a “differential acceleration (DA)” value corresponds to the differences between an acceleration reading or measurement in at least two sampling instances, such as in a current sampling instance and a previous sampling instance (e.g., a previous iteration of method (300b)).

At (406a), a determination is made as to whether both, or one of, the DP and DA exceed their respective predetermined threshold values. In some examples, the method may require that both the DP and DA are above their respective thresholds. In other cases, the method may only require that one of the DP and DA is above their respective thresholds.

In at least one example, separate predetermined thresholds may be defined for each of the DP and DA at (406a). For instance, in some instances, a DP above 0.2 mbar—between samples taken every minute—is used for the DP's predetermined threshold. For the DA, a change of 0.2 g between samples taken at 25 Hz is used for the DA's predetermined threshold.

If a positive determination is made at (406a), then the method (400a) can proceed directly to acts (408a) to (412a), which are analogous to acts (308a) to (312a) of method (300a) (FIG. 3A), respectively. Otherwise, the method can return to act (402a) to continue monitoring the pressure and acceleration data in new sampling instances.

FIG. 4B shows another process flow for an example method (400b) for pressure-based and acceleration-based motion tracking. In at least one example, method (400b) is executed by the processor (902), of the motion tracking system (104).

Analogous to method 300b (FIG. 3B), method (400b) can be used by the tracking system (104) to determine whether an asset (102) is no longer moving. In this case, the tracking system (104) can deactivate the location sensing unit (908) to conserve on-board power.

In some examples, method (400b) is provided as an extension of method (400a), and follows after act (412a) (FIG. 4A) (as shown). In other examples, method (400b) may be a stand-alone method, that occurs independently and/or separately from method (400a).

As shown, at (414b), the pressure and acceleration data is again monitored, using their respective sensors. At (416b), the differential pressure (DP) and differential acceleration (DA) sensors are again determined, in each iteration. In some examples, it is assumed that the location sensing unit (908) is activated (or intermittently activated) during acts (414b) and (416b), and continues to monitor and transmit location data (e.g., acts (410a) and (412a) in FIG. 4A).

At (418b), it is determined whether the DP and/or DA are below their respective predetermined thresholds. The predetermined thresholds can be the same, or different, from act (406a). In some examples, the method may require that both the DP and DA are below their respective thresholds. In other cases, the method may only require that one of the DP and DA is below their respective thresholds.

If so, the method proceeds to acts (420b) and (422b), which are generally analogous to acts (320b) and (322b), respectively, of method (300b) (FIG. 3B). In particular, the method may continue iterating until the DP and/or DA are below their respective thresholds, for a predetermined elapsed time or predetermined number of iterations of method (400b), sampling instances, etc. If so, the location sensing unit (908) is deactivated at (424b).

If the DA and/or DP are not below their respective thresholds, then the method can return to act (414b) to continue monitoring the pressure and acceleration data.

In some examples, act (422b) may not be necessary, and the method may directly proceed from act (420b) to act (424b).

Once act (424b) is completed, the method may return to iterating method (400a) (e.g., starting from act (402a)) to monitor if the asset (102) begins movement again. In this manner, the tracking system (104) can continuously cycle between methods (400a) and (400b) in order to activate and/or deactivate the location sensing unit (908), as needed. In other examples, if method (400b) is a stand-alone method, then the method simply terminates at act (424b).

### (iii.) One or More Sensor Types.

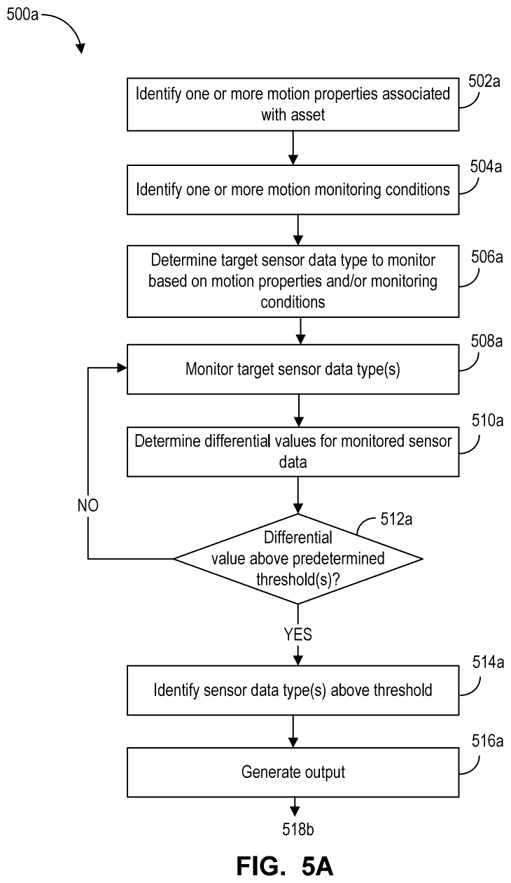

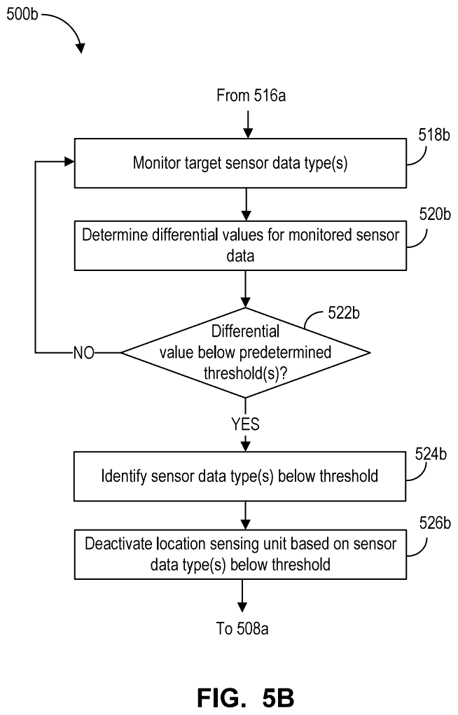

FIG. 5A is a process flow for an example method (500a) for motion tracking using one or more sensor types. Method (500a) can be executed by the processor (502), of the tracking system (104).

More generally, method (500a) can allow the tracking system (104) to determine which one of the pressure data and/or accelerometer data, is more suited for movement analysis. The specific choice between the pressure and accelerometer data may be based on: (i) the type of asset being monitored; and/or (ii) the type of movement monitored. In this manner, false positives and negatives are minimized, while maintaining overall accuracy. In some examples, method (500a) always uses the pressure data for motion tracking, but determines whether to further use the acceleration data in conjunction with the pressure data.

At (502a), the tracking system (104) identifies one or more asset motion properties associated with the asset.

For example, this includes determining whether the asset is prone to vibrating in stationary positions. If the system is vibration prone, the tracking system (104) may rely primarily on pressure data, rather than accelerometer data, to detect motion. This is because using accelerometer data may result in false positives each time the asset vibrates. However, the pressure data is less likely to be affect by stationary vibrations. In other cases, if the asset is not vibration prone, then one or both of pressure and acceleration data may be relied on.

The motion properties of the asset can be determined in various manners. In some examples, a user input specifies the type of asset being monitored, to the tracking system (104). For example, the tracking system (104) may include an input interface (e.g., coupled to the processor), which can allow a user to input the asset type being monitored. The tracking system (104) may store predefined reference data that correlates different asset types to different motion properties (e.g., vibrating versus non-vibrating assets). In this manner, the tracking system (104) can resolve the motion properties at act (502a). In other examples, the user input can involve directly inputting the motion properties of the asset into the tracking system (104).

It is also possible that the asset type and/or motion properties are received from an external computing device. For example, the computing device (115) can transmit instruction data to the tracking system (104) on the asset type being monitored and/or the motion properties of the asset being monitored.

In still other cases, the tracking system (104) can be pre-configured to monitor assets having known motion properties.

At (504a), the tracking system (104) can also identify one or more monitoring conditions. The monitoring conditions can indicate the type of motion being monitored.

For instance, monitoring conditions can include monitoring only displacement of the asset (102) over significant distances. In these cases, it is sufficient for the tracking system (104) to only rely on pressure data to activate the location sensing unit (908).

In other examples, the monitoring conditions can involve monitoring not only displacement, but also any disturbance to the asset (102). Accordingly, the tracking system (104) can monitor both pressure and acceleration data. Pressure data can indicate whether the asset has moved over significant distances, while acceleration data can monitor disturbances.

In some examples, the motion conditions are predefined in the tracking system (104). For instance, the monitoring conditions may be configured directly into the tracking system (104), or otherwise configured by user input (as explained in act (502a)) and/or remotely using an external computing device, e.g., computing device (115).

At (506a), based on the identifications made at (502a) and/or (504a)-in respect of the asset motion properties and/or monitoring conditions-the tracking system (104) can determine a target sensor data type to monitor. For example, as discussed above, this can include monitoring one or more of the pressure data and/or acceleration data from respective sensors.

In some examples, at least the pressure data is monitored. The results of acts (502a) and/or (504a) are then used to determine if acceleration data should also be monitored, in addition to the pressure data. For example, if act (502a) indicates that the use of accelerometer data will not result in false positives or false negatives, the accelerometer data can also be monitored in addition to the pressure data. In other cases, accelerometer data is only monitored if, additionally, act (504a) indicates that accelerometer data is useful for the motion monitoring conditions.

In other examples, acts (502a)-(506a) are preformed manually. For example, the tracking system (104) may be preconfigured to only rely on pressure data and/or acceleration data by the operator, based on the operators beforehand knowledge of the asset motion properties and desired motion conditions. It is also possible that one or both of acts (502a) and (504a) are disregarded, and the tracking system (104) is directly configured and/or preconfigured to monitor one or both of the pressure and acceleration data.

At (508a), the tracking system (104) can monitor the target sensor data types (e.g., pressure data and/or accelerometer data). In some examples, the location sensing unit (908) is deactivated, during the monitoring, to conserve battery power.

At (510a), for the monitored sensor data, respective differential values are determined for each type of monitored sensor data type. For example, this can include determining differential pressure (DP) values and/or differential acceleration (DA) values, as previously explained.

At (512a), it is determined whether the determined differential values exceed their respective predetermined thresholds. This can indicate that motion of the asset (102) is detected. In at least one example, if more than one sensor data is being monitored, then the differential values must exceed the threshold for at least one type of sensor data (e.g., pressure and/or acceleration).

If the determination is negative, at (512a), then the method can return to act (508a) to continue monitoring the target sensor data. Otherwise, at (514a), the tracking system (104) can identify the sensor data type(s) which had differential values that exceeded their predetermined thresholds (at 512(a)). For example, if more than one sensor data type is monitored (e.g., pressure and acceleration), act (514a) can involve determining whether one or both of the pressure and acceleration data had differential values exceeding their threshold.

At (516a), the tracking system (104) can generate an output based on: (i) the type of sensor data determined, at (514a), to have differential values exceeding threshold; and (ii) the one or more monitoring conditions, previously identified at (504a).

For example, a monitoring condition may require generating an alert, and activating the location sensing unit (908), only if the asset (102) has been moved a significant distance. In this case, an alert is generated and the sensing unit (912) activated, only if the differential pressure (DP) values exceeded threshold, at (512a). This can indicate significant displacement of the asset (102).

In other examples, the monitoring conditions may require generating an alert, and activating the sensing unit (908), if there is a disturbance of the asset (102). That is, any disturbance, irrespective of whether or not the asset (102) is significantly displaced. In this example, an alert is generated and the sensing unit (908) activated, only if the differential acceleration (DA) values exceeded threshold, at (512a). A change in acceleration indicates some disturbance of the asset (102).

In still other examples, the monitoring conditions may require generating an alert if there is a disturbance of the asset (102), but only activating the sensing unit (908) is the asset (102) has moved a significant distance. In this case, an alert output is generated at (516a) if only the DA exceeded threshold, but the location sensing unit (912) is only activated if the DP exceeded threshold.

To this end, the types of outputs generated (516a), by the location sensing unit (908), can be similar to (312a) (FIG. 3A).

FIG. 5B is a process flow for another example method (500b) for motion tracking using one or more sensor types. In at least one example, method (500b) is executed by the processor (902), of the motion tracking system (104).

Analogous to method (300b) (FIG. 3B), method (500b) can be used by the tracking system (104) to determine whether an asset (102) is no longer moving. In this case, the tracking system (104) can deactivate the sensing unit (908) to conserve on-board power.

At (518b), the tracking system (104) monitors the target sensor data, and determines the corresponding differential values (518b) (e.g., DP and DA). At (522b), it is determined if one or more of the differential values are below their predetermined threshold.

At (524b), the tracking system (104) identifies which sensor data types are determined to be below threshold. At (526b), based on the determination at (524b), the location sensing unit (908) may be deactivated to conserve battery (or put into sleep mode, etc.). For example, the location sensing unit (908) can be deactivated only if the DP is below threshold. In some cases, both types of target sensor data, identified at (506a) (FIG. 5A) should be below their respective thresholds.

Afterwards, the method may return to act (508a) (FIG. 5A) to continue monitoring the target sensor data types. In other cases, the method can return to one or more of acts (502a)-(506a).

### (iv.) Adjusting Thresholds.

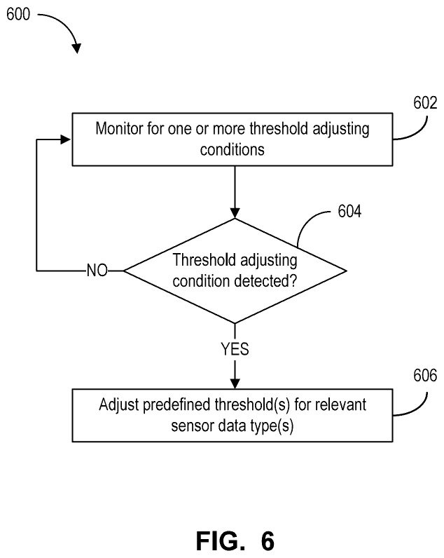

FIG. 6 is a process flow for another example method (600) for adjusting predetermined thresholds. For example, this can involve adjusting the thresholds used at acts (306a), (318b), (406a), (418b), (512a) and/or (522b). Method (600) can be used to separately adjust the predetermined thresholds for the DP and DA values. In some examples, method (600) is executed by the processor (902) of the tracking system (104).

As shown, at (602), the system can monitor for one or more threshold adjusting conditions. The threshold adjusting conditions may relate to various surrounding circumstances which can affect the sensitivity of the system to detecting motion using DP and/or DA values.

For example, a threshold adjusting condition can relate to the prevailing or current weather conditions. Changing weather conditions may affect pressure readings, and therefore, can factor into determining how high the threshold should be to detect motion using DP values while avoiding false positives.

In some examples, the tracking system (104) includes various sensors for monitoring weather conditions (e.g., temperature sensors, humidity sensors, etc.). Based on the output of these sensor(s), the tracking system (104) can determine a weather metric (or otherwise, a numerical index corresponding to the current weather state), and can further predefine an adjusted threshold for the DP, corresponding to the determined weather metric (e.g., based on a predefined mapping between different weather metrics and corresponding DP thresholds).

Another example threshold adjusting condition can relate to the topography of the surrounding region (e.g., degree of flatness) and/or the typical speed of the asset as it is moved through this topography. Topography and speed can also affect the magnitude of the DP peaks, and therefore, how low the threshold should be to avoid false negatives.

Accordingly, in some examples, the tracking system (104) can include sensor(s) for sensing the surrounding topography (e.g., level sensors). In other examples, the tracking system (104) can simply store data about the surrounding topography, as well as the expected speed of the asset (e.g., if it were moved). Based on the topography and/or speed, the tracking system (104) can calibrate the predefined thresholds for the DP, e.g., based on predefined mappings between topography and/or speed, and corresponding DP thresholds.

The strength of the asset (e.g., mass) can also affect how low the DA threshold can be set without generating false positives.

In at least one example, the tracking system (104) can also monitor the correlation between historical (or previous) DP and DA values, and whether motion in fact occurred. Based on these historical patterns, the system can adjust or calibrate the respective thresholds. In some instances, the tracking system (104) includes machine learning models that are trained on historical data, and which can predict DP and DA threshold values corresponding to motion, and which takes into account various threshold adjusting conditions.

At (604), it is determined if a threshold adjusting condition is detected. If not, the method can return to act (602) to continue monitoring. Otherwise, at (606), the respective pre-defined threshold is adjusted for the relevant sensor data type (e.g., pressure or acceleration data).

### (v.) Combining Methods.

The methods described in FIGS. 3 to 5 can be combined in any manner whatsoever. For example, any one of the methods (300a) (FIG. 3A), (400a) (FIG. 4A) and (500a) (FIG. 5A), can be combined with any one of reciprocal methods (300b) (FIG. 3B), (400b) (FIG. 4B) and/or (500b) (FIG. 5B). For example, in method (300a), after act (312a), the tracking system can then implement any one of methods (300b) (FIG. 3B), method (400b) (FIG. 4B) and/or method (500b) (FIG. 5B), or vice-versa Further, method (600) can be used in conjunction with any of the methods described in FIGS. 3A to 5B.

### (vi.) Real-Time or Non-Real Time Application.

Example methods in FIGS. 3A-5B can be performed in real time or near real time. For example, the methods can be implemented as new pressure data and/or acceleration data is being generated in real time. In other cases, the methods can be performed after the fact. For example, the methods can process previously collected pressure and/or acceleration sensor data—generated at various sampling time instances—to determine retroactively if an asset has moved.

### III. Example Hardware Configuration

FIG. 9 shows an example simplified hardware configuration for the motion tracking system (104). As shown, the motion tracking system (104) can include at least one processor (902), coupled via a data bus (950) to a memory (904), and one or more of at least one pressure sensor (906a), at least one accelerometer (906b), one or more location sensing units (908), an input/output (I/O) interface (910), at least one power source (912) and a communication interface (914).

Processor (902) includes one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), and digital signal processors.

Memory (904) comprises a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

To that end, it will be understood by those of skill in the art that references herein to the motion tracking system (104) as carrying out a function or acting in a particular way imply that processor (902) is executing instructions (e.g., a software program) stored in memory (904) and possibly transmitting or receiving inputs and outputs via one or more interfaces. For example, these can include instructions for executing any one of the methods of FIGS. 3A, 3B, 4A, 4B, 5A, 5B and 6.

Pressure sensor(s) (906a) can include any type of sensor for monitoring surrounding atmospheric pressure, and generate pressure data. For example, this can include strain gauges and MEMs (Micro-Electro Mechanical Systems) devices (e.g., Adafruit™ MS8607 Pressure Humidity Temperature sensor). In some examples, the pressure sensor (906a) is configured to generate a new sample reading, every 1 minute (e.g., a 1/60 Hz frequency sampling rate).

Accelerometer(s) (906b) can likewise include any type of sensor configured to monitor acceleration, and generate acceleration data. This includes various 2-axis and/or 3-axis accelerometers (e.g., MEMSIC™ MC3419 3-axis accelerometer). The accelerometer (906b) may be configured with a 25 Hz sampling rate. In this manner, the system can include a pressure senor (906a) operating at a 1/60 Hz frequency, and an accelerometer operating at a 25 Hz sampling frequency.

In some examples, the tracking system (104) only includes pressure sensors (906a), without accelerometers (906b).

Location sensing unit (908) can monitor the position of the tracking system (104), and generate location data. In at least one example, the location sensing unit comprises a global navigation sattelite system (GNSS), which can include a ground positioning system (GPS), GLObalnaya NAvigatsionnaya Sputnikovaya Sistema (GLONASS), BeiDou, or the like. In other examples, the location sensing unit (908) can monitor location using any other suitable means, e.g., using cellular or WiFi™ signals as known in the art.

Input/output (I/O) interface (910) includes any interface for connecting the tracking system (104) to other components or elements. Communication interface (914) may comprise, for example, a cellular modem and antenna (or WiFi™ or Bluetooth™) for wireless transmission of data to the communications network, e.g., network (110) in FIG. 1.

Power source (912) can comprise any source for on-board energy, or power. For example, power source (912) can include a direct current (DC) and/or alternative current (AC) battery pack. In other examples, the power source (912) can also be a source of renewable energy (e.g., a solar panel). Still further, power source (912) may be externally provided.

To that end, power source (912) may be a low energy power source. In some examples, the power source (912) is 3.6V with a capacity of 2200 mAh, e.g., a battery pack.

In some examples, all of the components illustrated in FIG. 9, as being part of the motion tracking system (104), are encapsulated in a single enclosure (as shown in FIG. 1). In other cases, the components may be distributed, e.g., distributed in different locations around the asset (104).

In some examples, all of the components in the system (104) are coupled to receive power from a common power source (912) (e.g., an on-board battery). In other words, at least the pressure sensor(s) (906a), accelerometers (906b) and location sensing unit (908) are all receiving power from a common power source (912). In this case, using the pressure sensor(s) (906a) and accelerometer(s) (906b), as described in the methods above, allows conserving power from power source (912) by selecting activating/deactivating the location sensing unit (908).

To the extent that the above description has referenced the motion tracking system as including any further components, e.g., other sensors, it will be understood that these further components may be further coupled to the computer bus (950).

### IV. Interpretation

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A method for pressure-based motion tracking, comprising:
monitoring pressure data generated by at least one pressure sensor of a pressure-based motion tracking system, wherein the pressure data is generated at sampling instances;
determining differential pressure (DP) values from the pressure data, wherein the DP values correspond to a difference in the pressure data between at least two sampling instances;
determining if the DP values exceed a predetermined threshold; and
if the DP values exceed the predetermined threshold, generating an output indicating that an asset, associated with the motion tracking system, has moved.

2. The method of claim 1, wherein the predetermined threshold is 0.2 millibars.

3. The method of claim 1, wherein if the DP values exceed the predetermined threshold, the method further comprises activating a location sensing unit, of the motion tracking system, to output location data.

4. The method of claim 3, wherein the location sensing unit comprises a global navigation satellite system (GNSS).

5. The method of claim 3, wherein the predetermined threshold is a first predetermined threshold, and wherein after activating the location sensing unit, the method further comprises:
continuing monitoring the pressure data generated by the at least one pressure sensor;
determining the DP values from the pressure data;
determining if the DP values fall below a second predetermined threshold; and
if the DP values fall below the second predetermined threshold, deactivating the location sensing unit.

6. The method of claim 5, further comprising determining if the DP values fall below the second predetermined threshold for a period of time.

7. The method of claim 5, wherein the first predetermined threshold is the same or different from the second predetermined threshold.

8. The method of claim 3, further comprising:
monitoring acceleration data generated by at least one accelerometer of the motion tracking system;
determining differential acceleration (DA) values from the acceleration data; and
activating the location sensing unit if one or more of the DP and DA values exceed a respective predetermined threshold.

9. The method of claim 3, further comprising:
identifying one or more of (i) motion properties of the asset, and (ii) target movement conditions;
based on the identifying, determining to monitor accelerometer data, in addition to the pressure data;
monitoring acceleration data generated by at least one accelerometer of the motion tracking system;
determining differential acceleration (DA) values from the acceleration data; and
activating the location sensing unit if one or more of the DP and DA values exceed a respective predetermined threshold.

10. The method of claim 1, further comprising monitoring one or more threshold adjusting conditions, and adjusting the predetermined threshold if a threshold adjusting condition is detected.

11. A pressure-based motion tracking system, comprising:
at least one pressure sensor; and
at least one processor coupled to the at least one pressure sensor, and configured for:
monitoring pressure data generated by the at least one pressure sensor, wherein the pressure data is generated at sampling instances;
determining differential pressure (DP) values from the pressure data, wherein the DP values correspond to a difference in the pressure data between at least two sampling instances;
determining if the DP values exceed a predetermined threshold; and
if the DP values exceed the predetermined threshold, generating an output indicating that an asset, associated with the motion tracking system, has moved.

12. The system of claim 11, wherein the predetermined threshold is 0.2 millibars.

13. The system of claim 11, wherein the system further comprises a location sensing unit coupled to the at least one processor, and if the DP values exceed the predetermined threshold, the at least one processor is further configured for activating the location sensing unit, of the motion tracking system, to output location data.

14. The system of claim 13, wherein the location sensing unit comprises a global navigation satellite system (GNSS).

15. The system of claim 13, wherein the predetermined threshold is a first predetermined threshold, and after activating the location sensing unit, the at least one processor is further configured for:
continuing monitoring the pressure data generated by the at least one pressure sensor;
determining the DP values from the pressure data;
determining if the DP values fall below a second predetermined threshold; and
if the DP values fall below the second predetermined threshold, deactivating the location sensing unit.

16. The system of claim 15, further comprising determining if the DP values fall below the second predetermined threshold for a period of time.

17. The system of claim 15, wherein the first predetermined threshold is the same or different from the second predetermined threshold.

18. The system of claim 13, wherein the system further comprises at least one accelerometer coupled to the at least one processor, and the at least one processor is further configured for:
monitoring acceleration data generated by the at least one accelerometer;
determining differential acceleration (DA) values from the acceleration data; and
activating the location sensing unit if one or more of the DP and DA values exceed a respective predetermined threshold.

19. The system of claim 13, wherein the system further comprises at least one accelerometer coupled to the at least one processor, wherein the at least one processor is further configured for:
identifying one or more of (i) motion properties of the asset, and (ii) target movement conditions;
based on the identifying, determining to monitor accelerometer data, in addition to the pressure data;
monitoring acceleration data generated by the at least one accelerometer;
determining differential acceleration (DA) values from the acceleration data; and
activating the location sensing unit if one or more of the DP and DA values exceed a respective predetermined threshold.

20. The system of claim 1, wherein the at least one processor is further configured to monitor one or more threshold adjusting conditions, and adjusting the predetermined threshold if a threshold adjusting condition is detected.
